(19) United States
(12) Patent Application Publication
(10) Pub. No.: US 2011/0026770 A1
(43) Pub. Date: Feb. 3, 2011

(54) Person Following Using Histograms of Oriented Gradients

(76) Inventor: Jonathan David Brookshire, Cambridge, MA (US)

Correspondence Address: O'Brien Jones, PLLC (w/iRobot Corp.), 1951 Kidwell Drive, Suite 550 B, Tysons Corner, VA, 22182, US

(21) Appl. No.: 12/848,677

(22) Filed: Aug. 2, 2010

Related U.S. Application Data
(60) Provisional application No. 61/230,545, filed on Jul. 31, 2009.

(51) Int. Cl. G06K 9/00

(52) U.S. Cl. 382/103

(57) ABSTRACT

A method for using a remote vehicle having a stereo vision camera to detect, track, and follow a person, the method comprising: detecting a person using a video stream from the stereo vision camera and histogram of oriented gradient descriptors; estimating a distance from the remote vehicle to the person using depth data from the stereo vision camera; tracking a path of the person and estimating a heading of the person; and navigating the remote vehicle to an appropriate location relative to the person.

### FIELD

The present teachings relate to person detection, tracking, and following with a remote vehicle such as a mobile robot.

### BACKGROUND

For remote vehicles to effectively interact with people in many desirable applications, remote vehicle control systems must first be able to detect, track, and follow people. It would therefore be advantageous to develop a remote vehicle control system allowing the remote vehicle to detect a single, unmarked person and follow that person using, for example, stereo vision. Such a system could also be used to support gesture recognition, allowing a detected person to interact with the remote vehicle the same way he or she might interact with human teammates.

It would also be advantageous to develop a system that enables humans and remote vehicles to work cooperatively, side-by-side, in real world environments.

### SUMMARY

The present teachings provide a method for using a remote vehicle having a stereo vision camera to detect, track, and follow a person, the method comprising: detecting a person using a video stream from the stereo vision camera and histogram of oriented gradient descriptors; estimating a distance from the remote vehicle to the person using depth data from the stereo vision camera; tracking a path of the person and estimating a heading of the person; and navigating the remote vehicle to an appropriate location relative to the person.

The present teachings also provide a remote vehicle configured to detect, track, and follow a person. The remote vehicle comprises: a chassis including one or more of wheels and tracks; a three degree-of-freedom neck attached to the chassis and extending generally upwardly therefrom; a head mounted on the chassis, the head comprising a stereo vision camera and an inertial measurement unit; and a computational payload comprising a computer and being connected to the stereo vision camera and the inertial measurement unit. The neck is configured to pan independently of the chassis to keep the person in a center of a field of view of the stereo vision camera while placing fewer requirements on the motion of the chassis. The inertial measurement unit provides angular rate information so that, as the head moves via motion of the neck, chassis, or slippage, readings from the inertial measurement unit allow the computational payload to update the person's location relative to the remote vehicle.

Additional objects and advantages of the present teachings will be set forth in part in the description which follows, and in part will be obvious from the description, or may be learned by practice of the teachings. The objects and advantages of the present teachings will be realized and attained by the elements and combinations particularly pointed out in the appended claims.

Both the foregoing general description and the following detailed description are exemplary and explanatory only and are not restrictive of the present teachings, as claimed.

The accompanying drawings, which are incorporated in and constitute a part of this specification, illustrate an exemplary embodiment of the present teachings and, together with the description, serve to explain the principles of those teachings.

### BRIEF DESCRIPTION OF THE DRAWINGS

FIG. 1 is a schematic diagram illustrating inputs for person detection, tracking, and following in accordance with embodiments of the present teachings.

FIG. 1A illustrates an exemplary person training image (left) and its gradient (right).

FIG. 2 illustrates an exemplary embodiment of a remote vehicle in accordance with the present teachings.

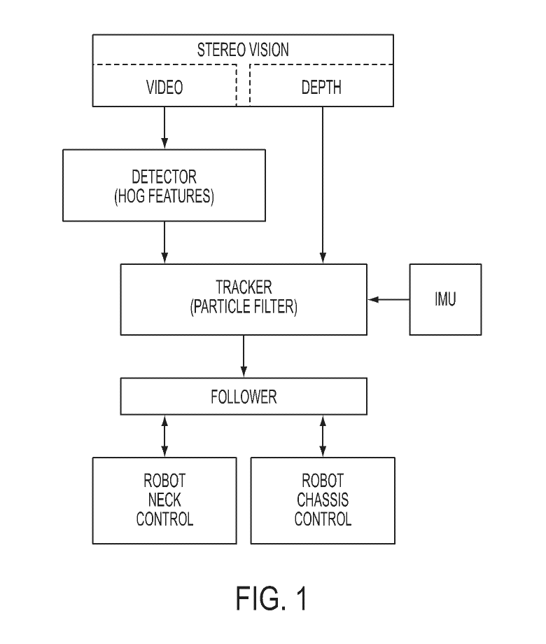

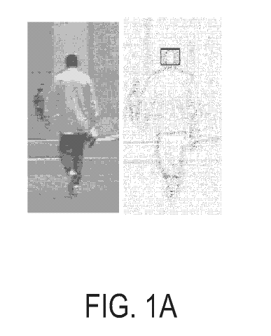

FIG. 1 illustrates an embodiment of a remote vehicle following a person at a predetermined distance.

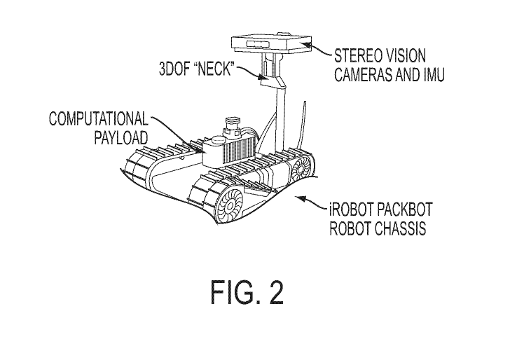

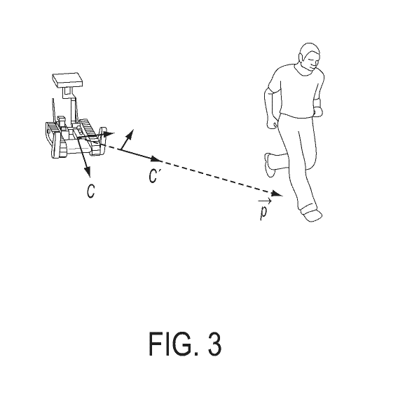

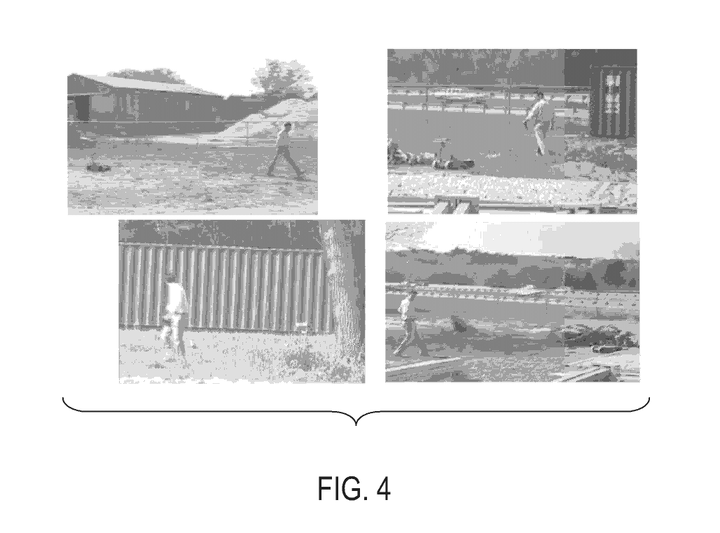

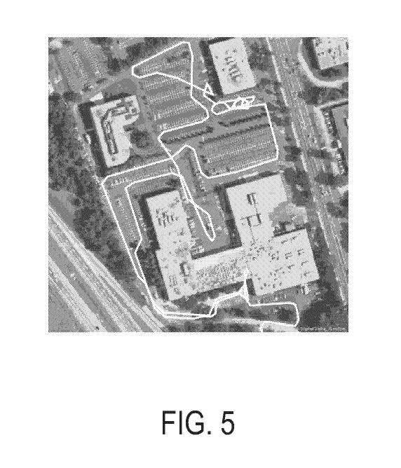

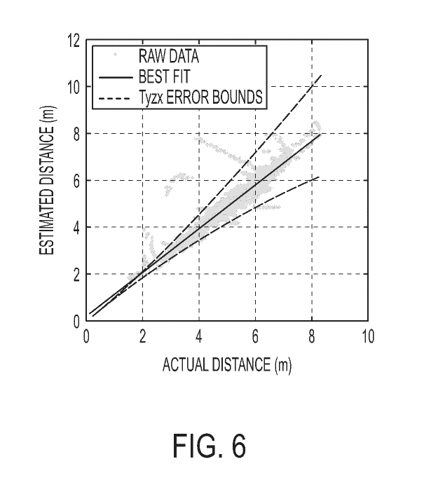

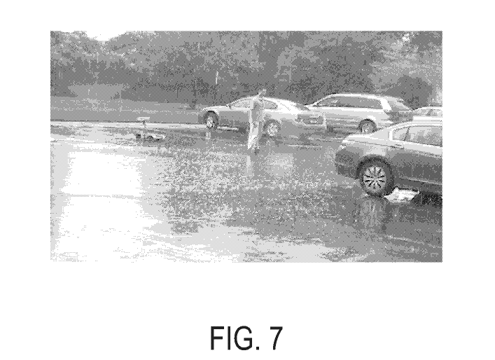

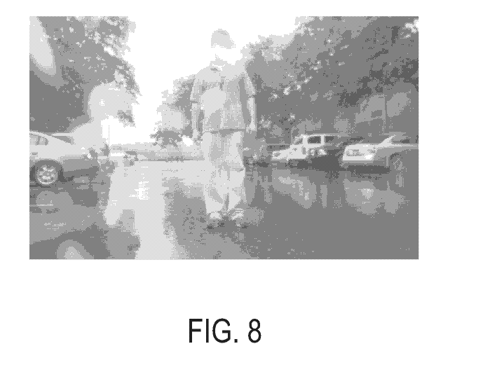

FIG. 2 provides video captures of an exemplary remote vehicle detecting and following a person walking forward, backward, and to the side.

FIG. 5 illustrates an exemplary outdoor path over which a remote vehicle can follow a person.

FIG. 3 is a sample plot comparing a remote vehicle's actual and estimated distance from a person that was detected and followed.

FIG. 4 illustrates an exemplary embodiment of a remote vehicle following a person during a rainstorm.

FIG. 5 illustrates an exemplary embodiment of a rain-obscured view from the remote vehicle of FIG. 7.

### DETAILED DESCRIPTION

As a method for remote vehicle interaction and control, person following should operate in real-time to adapt to changes in a person's trajectory. Some existing person-following solutions have found ways to simplify perception. Dense depth or scanned-range data has been used to effectively identify and follow people, and depth information from stereo cameras has been combined with templates to identify people. Person following has also been accomplished by fusing information from LIDAR with estimates based on skin color. Existing systems rely primarily on LIDAR data to perform following.

Some methods have been developed that rely primarily on vision for detection, but attempt to learn features of a particular person by using two cameras and learning a color histogram describing that person. Similar known methods use color space or contour detection to find people. These existing systems can be unnecessarily complex.

A person-following system in accordance with the present teachings differs from existing person-following systems because it utilizes depth information only to estimate a detected person's distance. A person-following system in accordance with the present teachings also differs from known person-following systems because it uses a different set of detection features—Histograms of Oriented Gradients (HOG)—and does not adjust the tracker to any particular person in a scene. Person detection can be accomplished with a single monochromatic video camera.

The present teachings provide person following by leveraging HOG features for person detection. HOG descriptors are feature descriptors used in computer vision and image processing for object detection. The technique counts occurrences of gradient orientation in localized portions of an image, and is similar to edge orientation histograms, scale-invariant feature transform descriptors, and shape contexts, but differs in that it provides a dense grid of uniformly spaced cells and uses overlapping local contrast normalization for improved accuracy.

The essential thought behind HOG descriptors is that local object appearance and shape within an image can be described by the distribution of intensity gradients or edge directions. The implementation of these descriptors can be achieved by dividing the image into small connected regions, called cells, and for each cell compiling a histogram of gradient directions or edge orientations for the pixels within the cell. The combination of these histograms then represents the descriptor. For improved accuracy, the local histograms can be contrast-normalized by calculating a measure of the intensity across a larger region of the image, called a block, and then using this value to normalize all cells within the block. This normalization results in better invariance to changes in illumination or shadowing.

HOG descriptors can provide advantages over other descriptors. Since HOG descriptors operate on localized cells, a method employing HOG descriptors upholds invariance to geometric and photometric transformations. Moreover, coarse spatial sampling, fine orientation sampling, and strong local photometric normalization can permit body movement of persons to be ignored so long as they maintain a roughly upright position. The HOG descriptor is thus particularly suited for human detection in images.

Using HOG, person detection can be performed at over 8 Hz using video from a monochromatic camera. The person's heading can be determined and combined with distance from stereo depth data to yield a 3D estimate of the person being tracked. Because the present teachings can determine the position of the camera (i.e., the “head”) relative to the remote vehicle and can determine the bearing and distance of the person relative to the camera, we can calculate a 3D estimate of the person relative to the remote vehicle.

A particle filter having clutter rejection can be employed to provide a continuous track, and a waypoint following behavior can servo the remote vehicle (e.g., an iRobot® PackBot®) to a destination behind the person. A system in accordance with the present teachings can detect, track, and follow a person over several kilometers in outdoor environments, demonstrating a level of performance not previously shown on a remote vehicle.

In accordance with certain embodiments of the present teachings, the remote vehicle and the person to be followed are adjacent in the environment, and operation of the remote vehicle is not the person's primary task. Being able to naturally and efficiently interact with the remote vehicle in this kind of situation requires advances in the remote vehicle's ability to detect and follow the person, interpret human commands, and react to its environment with context and high-level reasoning. The exemplary system set forth herein deals with keeping the remote vehicle adjacent to a human, which involves detecting a human, tracking his/her path, and navigating the remote vehicle to an appropriate location. With the ability to detect and maintain a distance from the human, who may be considered the remote vehicle's operator, the remote vehicle can use gesture recognition to receive commands from the human. An example of a person-following application is a robotic “mule” that hauls gear and supplies for a group of dismounted soldiers. The same technology could be used as a building block for a variety of applications ranging from elder care to smart golf carts.

In accordance with various embodiments, the present teachings provide person following on a remote vehicle using only vision. As shown in the schematic diagram of FIG. 1, person detection can be performed using a video stream from a single camera of a stereo pair of cameras. When using a stereo pair of cameras, the stereo depth data can be used only to estimate the person's distance. To ensure that person following can be successfully implemented in accordance with the present teachings, it can be advantageous to ascertain the level of performance that is required from the detector for effective following (e.g., the maximum tolerable false positive rate), and to quantify accuracy of the system with respect to its ability to follow people. Exemplary trials to determine such accuracy and performance are set forth hereinbelow.

An exemplary implementation of a system in accordance with the present teachings was developed on an iRobot® PackBot® and is illustrated in FIG. 2. A stereo depth sensor was readily available for the exemplary iRobot® PackBot® platform in a rugged enclosure, providing an inexpensive path to a deployable system. In an exemplary implementation, the iRobot® PackBot® was upgraded with a standard, modular computational payload comprising an Intel® 1.2 GHz Core 2 Duo-based computer, GPS (not used in this implementation), LIDAR (used only for ground truth in this implementation, as described below), and an IMU. A Tyzx G2 stereo camera pair (“head”) was mounted at the top of a 3-DOF neck. During following, only the pan (left-right camera movement) axis of the neck was moved to keep the target in the center of the field of view. By decoupling the orientation of the head and the chassis, the remote vehicle can maintain tracking while placing fewer requirements on the motion of the chassis. In accordance with certain embodiments, the remote vehicle has a top speed of about 2.2 m/s (about 5 MPH). The person-following software can, for example, be written in or compatible with the iRobot® Aware 2.0 Intelligence Software.

Certain embodiments of the present teachings utilize a tracker, described hereinafter, comprising a particle filter with accommodations for clutter.

### Detection

Various embodiments of a person detection algorithm in accordance with the present teachings utilize Histogram of Oriented Gradient (HOG) features, along with a series of machine learning techniques and adaptations that allow the system to run in real time. The person detection algorithm can utilize learning parameters and make trade-offs between speed and performance. A brief discussion of the detection strategy is provided here to give context to the trade-offs.

In certain embodiments, the person detection algorithm learns a set of linear Support Vector Machines (SVMs) trained on positive (person) and negative (non-person) training images. This learning process generates a set of SVMs, weights, and image regions that can be used to classify an unknown image as either positive (person) or negative (non-person).

SVMs can be defined as a set of related supervised learning methods used for classification and regression. Since a SVM is a classifier, then given a set of training examples, each marked as belonging to one of two categories, a SVM training algorithm builds a model that predicts whether a new example falls into one category or the other. Intuitively, a SVM model is a representation of the examples as points in space, mapped so that the examples of the separate categories are divided by a clear gap that is as wide as possible. New examples are then mapped into that same space and predicted to belong to a category based on which side of the gap they fall on.

To perform person following, a descriptive set of features must be found. If the feature set is rich enough—that is, if it provides sufficient information to identify targets—these features can be combined with machine learning algorithms to classify targets and non-targets. HOG features can be utilized for person detection. In such a detection process, the gradient is first calculated for each pixel. Next, the training image (see FIG. 1A) is divided into a number of sub-windows, often referred to as “blocks”. The block size can span from about 8 pixels to about 64 pixels, can have various length-to-width ratios, and can densely cover the image (i.e., the blocks can overlap). Each block can be divided into quadrants and the HOG of each quadrant can be calculated.

The person detection algorithm can learn what defines a person by examining a series of positive and negative training images. During this learning process, a single block can be randomly selected (e.g., see FIG. 1A). Because this process can be time consuming and does not need to be repeated, it can be performed off line. The HOG for this block can be calculated for a subset of the positive and negative training images. Using a subset can improve learning via N-fold cross validation. A linear SVM can then be trained on the resulting HOGs to develop a maximally separating hyperplane. Blocks that distinguish humans and non-humans well will result in a quality, efficient SVM classifier (hyperplane). Blocks that do not distinguish humans and non-humans well will result in poorly performing SVM classifiers (hyperplanes). The SVM's performance, then, can represent the performance of a particular block.

In general, a single block will not be sufficient to classify positive and negative images successfully. Further, weak block classifiers can be combined to form stronger classifiers. However, an AdaBoost algorithm, as described in R. Schapire, The boosting approach to machine learning: An overview, MSRI Workshop on Nonlinear Estimation and Classification (2001), the disclosure of which is incorporated by reference herein, provides a statistically-founded means to choose and weight a set of weak classifiers. The AdaBoost algorithm repeatedly trains weak classifiers and weights and sums the score from each classifier into an overall score. A threshold is also learned which provides a binary classification.

Performance can be further improved by recognizing that, as a pixel detection window (e.g., a 64×128 pixel detection window) is scanned across an image, many of the detection windows can be easily classified as not containing a person. A rejection cascade, as disclosed in Q. Zhu et al., Fast Human Detection Using a Cascade of Histograms of Oriented Gradients, IEEE Computer Society Conference on Computer Vision and Pattern Recognition (2006), Vol. 2, No. 2, pp 1491-1498, the contents of which is incorporated by reference herein, can be employed to easily classify detection windows that do not contain a person. For purposes of the present teachings, a rejection cascade can be defined as a set of AdaBoost-learned classifiers or “levels.”

In an exemplary implementation of a system in accordance with the present teachings, the learning process can be distributed onto 10 processors (e.g., using an MPICH (message passing interface) multiprocessor software architecture) to decrease training time. At the present time, training on 1000 positive and 1000 negative images from an Institut national de recherche en informatique et en automatique (INRIA) training dataset can take about two days on 10 such processors.

To detect people at various distances and positions, a detection window (e.g., a 64×128 pixel detection window) can be scanned across the image in position and scale. Monochrome video is 500×312 pixels and, at 16 zoom factors, can require a total of 6,792 detection evaluations per image. With this many evaluations, scaling the image, scanning the detection window, and calculating the HOG can take too long. To compensate, in accordance with certain embodiments of the present teachings, the person detection algorithm can apply Integral Histogram (IH) techniques as described in Q. Zhu et al. (cited above) and P. Viola et al., Rapid Object Detection using a Boosted Cascade of Simple Features, Proceedings of IEEE Conference on Computer Vision and Pattern Recognition (2001), Vol. 1, p. 511, the contents of which is incorporated by reference herein.

In accordance with various embodiments, in addition to using the IH technique, performance can be improved by scaling the IH rather than scaling the image. In such embodiments: (1) the IH is calculated for the original image; (2) the IH is scaled; and (3) the HOG features are calculated. This process can be appropriate for real-time operation because the IH is calculated only once in step (1), the scaling in step (2) need only be an indexing operation, and the IH provides for speedy calculation of the HOG in step (3). By scaling the IH instead of scaling the image directly, the processing time can be reduced by about 64%. It is worth noting, however, that the two strategies are not mathematically equivalent. Scaling the image (e.g., with bilinear interpolation) and then calculating the IH is not the same as calculating the IH and scaling it. However, both algorithms can work well in practice and the latter can be significantly faster without an unacceptable loss of accuracy for many intended applications.

### Tracking

The task of the tracking algorithm is to filter incoming person detections into a track that can be used to continuously follow the person. The tracking algorithm is employed because raw person detections cannot be tracked unfiltered. The detector can occasionally fail to detect the person, leaving an unfiltered system without a goal location for a period of time. Additionally, the detector can occasionally detect the person in a wrong position. An unfiltered system might veer suddenly based on a single spurious detection. A particle filter implementation can mitigate affects of missing and incorrect detections and enforce limits on the detected person's motions. Using estimates of the camera's parameters and the pixel locations of the detections, the heading of the person can be estimated. The distance of the person from the remote vehicle's head can then be estimated directly from the stereo camera's depth data.

Exemplary implementations of a system in accordance with the present teachings can use a single target tracker that filters clutter and smooths the response when the person is missed. In the case of a moving remote vehicle chasing a moving target, the tracker must account for both the motion of the remote vehicle and the motion of the target.

Target tracker clutter filtering can be performed using a particle filter where each particle is processed using a Kalman filter. The person's state can be represented as x=[x,y,z,\dot{x},\dot{y},ż]^{T}. Each particle includes the person's state and covariance matrix. Each person detection in each frame can trigger an update cycle where the input detections are assumed to have a fixed covariance. The prediction stage can propagate the person's state based on velocity and noise parameters.

The particle filter can maintain, for example, 100 hypotheses about the position and velocity (collectively, the state) of the person. 100 hypotheses provide sufficient chance that a valid hypothesis is available. The state can be propagated by applying a position change proportional to the estimated velocity. The state can also be updated with new information about target position and velocity when a detection is made. During periods when no detection is made, the state is simply propagated assuming the person moves with a constant velocity—that is, the tracker simply guesses where the person will be based on how they were moving. When a detection is made, the response is smoothed because the new detection is only partially weighted—that is, the tracker does not completely “trust” the detector and only slowly incorporates the detector's data.

Motion of the Remote Vehicle. The state of the remote vehicle (e.g., its position and velocity) can be incorporated as part of the system state and modeled by the particle filter. To avoid added computational complexity, however, the present teachings contemplate simplifying the modeling by assuming that the motion of the remote vehicle chassis is known. The stereo vision head can comprise an IMU sensor that provides angular rate information. As the head moves (either from the motion of the neck, chassis, or slippage), readings from the IMU allow the system to update the person's state relative to the remote vehicle. If A is the rotation matrix described by the angular accelerations for some time, then:

$$R = [ \begin{matrix}A & 0 \\ 0 & A\end{matrix} ]$$

$${x}^{′} = Rx$$

$${Σ}_{x}^{′} = R {Σ}_{x} {R}^{T}$$

where x′ and Σ′ₓ are a new state and covariance of the particle, respectively. Assuming that the accelerations and remote vehicle chassis motion had no noise can be reasonable. Unlike, for example, mapping applications where accelerometer noise may accumulate, the present teachings can utilize accelerations to servo the head relative to its current position, so that absolute position is not necessary. Additionally, the symmetric nature of Σₓ can be programmatically enforced to prevent accumulation of small computational errors in the 32-bit floats, which can cause asymmetry.

Clutter. Occasionally, the detector can generate spot noise, or clutter. Clutter detections are relatively uncorrelated and may appear for only a single frame. However, they can be at drastically different positions from the target and may negatively affect tracking. As described in S. Särkkä et al., Rao-Blackwellized Particle Filter for Multiple Target Tracking, Information Fusion Journal (2007), Vol. 8, Issue 1, pp. 2-15, the contents of which is incorporated by reference herein, detections can be allowed to associate with a “clutter target” with some fixed likelihood (which can be thought of as a clutter density). For each particle individually, each detection can be associated either with the human target or the clutter target based on the variance of the human target and the clutter density. In other words, if a detection is very far from a particle, and therefore unlikely to be associated with it, the detection will be considered clutter. This process works well, but can degenerate when the target has a very large variance; the fixed clutter density threshold causes the majority of detections to be considered clutter and the tracker must be manually reset. This typically only occurs, however, when the tracker has been run for an extended period of time (several minutes) without any targets. The situation can be handled with a dynamic clutter density or a method to reset the tracker when variances become irrelevantly large.

### Following

The tracker can provide a vector \vec{p} that describes the position of a person relative to the remote vehicle chassis. The following algorithm, coordinates of which are illustrated in FIG. 1, can be a “greedy” tracker that attempts to take the shortest path (from C) to get several meters (or another predetermined distance) behind the person, facing the person (to C′).

The C′ frame can be provided as a waypoint to a waypoint module (e.g., for an iRobot® PackBot® Aware® 2.0 waypoint module). In an embodiment employing an Aware® 2.0 waypoint module, Aware® 2.0 Intelligence Software can use a model of the remote vehicle to generate a number of possible paths (which correspond to a rotate/translate drive command) that the remote vehicle might take. Each of these possible paths can be scored by the waypoint module and any other modules (e.g., an obstacle avoidance module). The command of the highest scoring path can then be executed.

Greedy following can work well outdoors, but can clip corners and thus can be less suitable for indoor use. For indoor following, it can be advantageous to either perform some path planning on a locally generated map or follow/servo the path of the person. Servoing along the person's path has the advantage of traveling a hopefully obstacle-free path of the person, but can result in unnecessary remote vehicle motion and may not be necessary for substantially obstacle-free outdoor environments.

As shown in the series of frame captures in FIG. 4, person following can be reasonably robust to changes in a detected person's pose, because forward, backward, and side aspects of the person can be detected reliably. In accordance with embodiments of the present teachings employing the above-mentioned iRobot® PackBot® upgraded with a payload comprising an Intel® 1.2 GHz Core 2 Duo-based computer, the remote vehicle can use about 70% of the 1.2 GHz Intel® Core 2 Duo computer and run its servo loop at an average of 8.4 Hz. The remaining processing power can be used, for example, for other complementary applications such as gesture recognition and obstacle avoidance.

A system in accordance with the present teachings can travel paths during person following that are similar to those shown in FIG. 5. The path shown in FIG. 5 is about 2.0 kilometers (1.25 miles) and was traversed and logged using a remote vehicle's GPS. The path traveled can include unimproved surfaces (such as the non-paved surface shown in FIG. 4) and paved parking lots and sidewalks (as shown in FIG. 5).

To characterize the ability of a system in accordance with the present teachings to follow a person, the estimated track position of a detected person can be compared to a ground truth position. Ground truth is a term used with remote sensing techniques where data is gathered at a distance. In remote sensing, remotely-gathered image data must be related to real features and materials on the ground. Collection of ground-truth data enables calibration of remote-sensing data, and aids in the interpretation and analysis of what is being sensed.

More specifically, ground truth can refer to a process in which a pixel of an image is compared to what is there in reality (at the present time) to verify the content of the pixel on the image. In the case of a classified image, ground truth can help determine the accuracy of the classification performed by the remote sensing software and therefore minimize errors in the classification, including errors of commission and errors of omission.

Ground truth typically includes performing surface observations and measurements of various properties of the features of ground resolution cells that are being studied on a remotely sensed digital image. It can also include taking geographic coordinates of the ground resolution cells with GPS technology and comparing those with the coordinates of the pixel being provided by the remote sensing software to understand and analyze location errors.

In a study performed to characterize the ability of a system in accordance with the present teachings to follow a person, an estimated track position of a detected person was compared to a ground truth position. A test case was conducted wherein nine test subjects walked a combined total of about 8.7 km (5.4 miles) and recorded their position relative to the remote vehicle as estimated by tracking. The test subjects were asked to walk at a normal pace (4-5 km/h) and try to make about the same number of left and right turns. Data from an on-board LIDAR was logged and the data was hand-annotated for ground truth.

Table 1 shows the results averaged from all test subjects in terms of error (in meters) between the estimated and ground truth (hand-annotated from LIDAR) positions for all test subjects. Without any corrections, the system tracked the test subjects within an average error of 0.2837 meters. The average spatial bias was 0.134 m in the x direction and 0.095 m in the y direction. The average temporal offset was 74 ms, which is less than the person tracker's frame period of about 120 ms.

TABLE 1

| | | | Standard | | |
|---|---|---|---|---|---|
| | Mean | Median | Deviation | Minimum | Maximum |
| | Error | Error | of Error | Error | Error |
| Uncorrected | 0.2837 | 0.2248 | 0.29019 | 0.001835 | 3.0691 |
| Spatially | 0.24239 | 0.18314 | 0.28382 | 0.001095 | 3.0915 |
| Corrected | | | | | |
| Temporally | 0.27811 | 0.2206 | 0.2994 | 0.001919 | 5.7675 |
| Corrected | | | | | |
| Spatio-temporally | 0.23513 | 0.17688 | 0.29361 | 0.001416 | 5.7499 |
| Corrected | | | | | |

Since the average temporal offset was less than a cycle of the detection algorithm, it can be considered an acceptable error. To better understand the overall tracking error, FIG. 3 shows a sample plot from one of the test subjects, comparing the test subject's actual and estimated distance from the remote vehicle. The dotted lines show the error bounds provided by a Tyzx G2 stereo camera pair. As can be seen from the best fit line, the system's estimates are slightly biased (13.8 cm bias at 5 meters actual distance), but still fall well within the sensor's accuracy limits. Some errors fall outside of the boundaries, but these are caused by cases when the person exited the camera's field of view and the tracker simply propagated the position estimate based on constant velocity.

FIG. 6 is a 2D histogram of a test person's position relative to the remote vehicle. The remote vehicle is located at (0, 0), oriented to the right. The intensity of the plot shows areas where the test subject spent most of their time. As can be seen, the system was able to place the remote vehicle about 5 m behind the person most frequently. The distribution of the test subject's position can reflect the test subject's dynamics (how fast the test subject walked and turned) and the remote vehicle's dynamics (how quickly the remote vehicle could respond to changes in the test subject's path).

To further characterize the exemplary person-following system described herein, person testing was performed outdoors in a rainstorm having an average hourly rainfall at 2.5 mm/hr (0.1 in/hr).

The exemplary iRobot® PackBot® person-following system described herein operated successfully despite a considerable build up of rain on the camera's protective window. The detector was able to locate the person in rain as illustrated in FIG. 7 creating an obstructed camera view as illustrated in FIG. 5. Depth data from the stereo cameras can degrade quickly in rainy conditions, since drops in front of either camera of a stereo vision system can cause large holes in depth data. The system, however, can be robust to this loss of depth data when an average of the person's distance is used. The mean track error in rain can thus be comparable to the mean track error in normal conditions, and the false positives per window (FPPW) can be, for example, 0.08% with a 17.3% miss rate.

A tracking system in accordance with the present teachings demonstrates person following by a remote vehicle using HOG features. The exemplary iRobot® PackBot® person-following system described herein uses monocular video for detections, stereo depth data for distance, and runs at about 8 Hz using 70% of the 1.2 GHz Intel® Core 2 Duo computer. The system can follow people at typical walking speeds at least over flat and moderate terrain.

The present teachings additionally contemplate implementing a multiple target tracker. The person detector described herein can produce persistent detections on other targets (other humans) or false targets (non-humans). For example, if two people are in the scene, the detector can locate both people. On the other hand, occasionally a tree or bush will generate a relatively stable false target. The tracker disclosed above resolves all of the detections into a single target, so that multiple targets get averaged together, which can be mitigated with a known multiple target tracker.

By way of further explanation, the person detector can detect more than one person in an image (i.e., it can draw a bounding box around multiple people in an input image). The remote vehicle, however, can only follow one person at a time. When the present teachings employ a single target tracker, the system can assume that there is only one person in the image. The present teachings also contemplate, however, employing a multiple target tracker that enables tracking of multiple people individually, and following a selected one of those multiple people.

More formally, a single target tracker assumes that every detection from the person detector is from a single person. Employing a multiple target tracker removes the assumption that there is a single target. Whereas the remote vehicle currently follows the single target, a multiple target tracker could allow the remote vehicle to follow the target most like the target it was following. In other words, the remote vehicle would be aware of, and tracking, all people in its field of view, but would only follow the person it had been following. The primary advantage of a multiple target tracker, then, is that the remote vehicle can “explain away” detections by associating them with other targets, and better locate the true target to follow.

Additionally, the present teachings contemplate supporting gesture recognition for identified people. Depth data can be utilized to recognize one or more gestures from a finite set. The identified gesture(s) can be utilized to execute behaviors on the remote vehicle. Gesture recognition for use in accordance with the present teachings is described in U.S. Patent Publication No. 2008/0253613, filed Apr. 11, 2008, titled System and Method for Cooperative Remote Vehicle Behavior, and U.S. Patent Publication No. 2009/0180668, filed Mar. 17, 2009, titled System and Method for Cooperative Remote Vehicle Behavior, the entire content of both published applications being incorporated by reference herein.

Other embodiments of the present teachings will be apparent to those skilled in the art from consideration of the specification and practice of the teachings disclosed herein. It is intended that the specification and examples be considered as exemplary only, with a true scope and spirit of the present teachings being indicated by the following claims.

What is claimed is:

1. A method for using a remote vehicle having a stereo vision camera to detect, track, and follow a person, the method comprising:
detecting a person using a video stream from the stereo vision camera and histogram of oriented gradient descriptors;
estimating a distance from the remote vehicle to the person using depth data from the stereo vision camera;
tracking a path of the person and estimating a heading of the person; and
navigating the remote vehicle to an appropriate location relative to the person.

2. The method of claim 1, wherein the heading of the person can be combined with the distance from the remote vehicle to the person to yield a 3D estimate of a location of the person.

3. The method of claim 1, further comprising filtering clutter from detection data derived from the video stream.

4. The method of claim 1, further comprising using a waypoint behavior to direct the remote vehicle to a destination behind the person.

5. The method of claim 1, wherein the remote vehicle is adjacent the person and controlling the remote vehicle is not the person's primary task.

6. The method of claim 1, wherein navigating the remote vehicle comprises performing a waypoint navigation behavior.

7. The method of claim 1, further comprising panning the stereo vision camera to keep the person in a center of a field of view of the stereo vision camera.

8. The method of claim 1, wherein detecting a person comprises learning a set of linear Support Vector Machines trained on positive and negative training images.

9. The method of claim 8, further comprising generating a set of Support Vector Machines, weights, and image regions configured to classify an unknown image as either positive or negative.

10. The method of claim 9, wherein detecting a person comprises calculating a gradient for each image pixel, dividing a training image into a number of blocks, selecting a number of individual blocks, calculating a histogram of oriented gradients for the selected blocks for a subset of the positive and negative training images, and training a Support Vector Machine on the resulting histograms of oriented gradients to develop an maximally separating hyperplane.

11. The method of claim 8, further comprising distributing the process of learning a set of linear Support Vector Machines trained on positive and negative training images onto more than one processor to decrease training time.

12. The method of claim 11, wherein detecting a person comprises applying an integral histogram technique.

13. The method of claim 12, further comprising scaling an integral histogram factor rather than scaling the image.

14. The method of claim 13, wherein scaling the internal histogram factor comprises calculating an integral histogram for the original image, scaling the integral histogram, for the original image and calculating the histogram of oriented gradients features.

15. The method of claim 1, wherein tracking a path of the person comprises filtering incoming detections into a track configured to be used to continuously follow the person.

16. The method of claim 1, wherein tracking a path of the person comprises using estimates of the stereo vision camera's parameters and pixel locations of the detections to estimate the person's heading.

17. The method of claim 1, wherein tracking a path of the person comprises estimating a distance between the person and the remote vehicle head from depth data received from the stereo vision camera.

17. The method of claim 1, wherein tracking a path of the person comprises using a single target tracker configured to filter clutter and smooth detection data when the person is not detected

18. The method of claim 17, wherein filtering clutter comprises using a particle filter where each particle is processed by a Kalman filter.

19. The method of claim 18, wherein the state of the remote vehicle can be incorporated as part of a system state and modeled by the particle filter.

20. The method of claim 1, wherein tracking a path of the person and estimating a heading of the person comprises determining a vector describing a position of the person relative to the remote vehicle.

21. The method of claim 20, wherein navigating the remote vehicle to an appropriate location relative to the person comprises servoing along the person's path.

22. The method of claim 20, wherein navigating the remote vehicle to an appropriate location relative to the person comprises taking a shortest path to get a predetermined distance behind the person, facing the person.

23. The method of claim 22, further comprising:
providing the shortest path to a waypoint following behavior;
generating possible paths that the remote vehicle can take;
scoring the paths with the waypoint following behavior and an obstacle avoidance behavior; and
executing the command of the highest scoring path.

24. A remote vehicle configured to detect, track, and follow a person, the remote vehicle comprising:
a chassis including one or more of wheels and tracks;
a three degree-of-freedom neck attached to the chassis and extending generally upwardly therefrom;
a head mounted on the chassis, the head comprising a stereo vision camera and an inertial measurement unit; and
a computational payload comprising a computer and being connected to the stereo vision camera and the inertial measurement unit,
wherein the neck is configured to pan independently of the chassis to keep the person in a center of a field of view of the stereo vision camera while placing fewer requirements on the motion of the chassis, and
wherein the inertial measurement unit provides angular rate information so that, as the head moves via motion of the neck, chassis, or slippage, readings from the inertial measurement unit allow the computational payload to update the person's location relative to the remote vehicle.

25. The remote vehicle of claim 24, wherein the head further comprises LIDAR connected to the computational payload, range data from the LIDAR being used for comparing the estimated track position of a detected person with a ground truth position.
